(19) United States
(12) Patent Application Publication
(10) Pub. No.: US 2009/0319593 A1
(43) Pub. Date: Dec. 24, 2009

(54) Optimized Message Format for Synchronization Flows Between Transaction Processing Systems

(75) Inventors: Michael David Brooks, Southampton (GB); Andrew Wright, Hampshire (GB)

Correspondence Address: DUKE W. YEE;YEE & ASSOCIATES, P.C., P.O. BOX 802333, DALLAS, TX, 75380, US

(73) Assignee: International Business Machines Corporation, Armonk, NY (US)

(21) Appl. No.: 12/141,599

(22) Filed: Jun. 18, 2008

(51) Int. Cl. G06F 15/16

(52) U.S. Cl. 709/201

(57) ABSTRACT

Illustrative embodiments provide a computer implemented method, a data processing system and a computer program product for synchronizing flows between transaction processing systems. In one illustrative embodiment, responsive to a failure or interruption in processing between systems, the computer implemented method locates all units of recovery for a particular connection to form a set of identified units of recovery and builds a single message containing the set of identified units of recovery. The computer implemented method further sends the single message from a sending system to a partner system for processing.

### BACKGROUND OF THE INVENTION

1. Field of the Invention

The present invention relates generally to an improved data processing system and more specifically to a computer implemented method, an apparatus and a computer program product for synchronizing flows between transaction processing systems.

2. Description of the Related Art

Transaction processing systems can collaborate together to support workloads distributed between the systems across a network connection. A global transaction executes in several different systems and any recoverable updates that the transaction performs can be coordinated using a two phase commit form of synchronization point management protocol. Failures of such systems or of the connections between them can result in work in progress being left in an incomplete state. Transactions left in an incomplete state then require resynchronization once communication between systems is re-established.

In busy systems there can be large numbers of transactions that may need to be synchronized in this way after a failure or outage. Each transaction to be synchronized requires several network flows to exchange the information needed to complete the operation. Network costs may then form a significant part of the processing overhead and may result in further delays to a connection being placed back into service while a synchronization of the transaction is attempted.

The operations involved in resynchronizing a global transaction consist of searching for outstanding work relating to a connection, building and sending a resynchronization message to another system that may have knowledge of another part of the global transaction. Upon receiving messages from another region requesting the completion of a particular transaction, the system then replies to systems that have raised resynchronization requests, and may force transactions to complete forwards or backwards based on the information in such messages.

A transaction processing system normally processes each outstanding global transaction in sequence, incurring network costs for each one. The messages that are sent between systems usually consist of only a few bytes of data. Each message then incurs the overhead of the transport layers that deliver the message into the network and extract the message when the message arrives at the message destination. Therefore, as the number of transactions requiring synchronization increases, so does the corresponding network overhead.

### BRIEF SUMMARY OF THE INVENTION

According to one embodiment of the present invention, responsive to a failure or interruption in processing between systems, the computer implemented method locates all units of recovery for a particular connection to form a set of identified units of recovery and builds a single message containing the set of identified units of recovery. The computer implemented method further sends the single message from a sending system to a partner system for processing.

### BRIEF DESCRIPTION OF THE SEVERAL VIEWS OF THE DRAWINGS

FIG. 1 depicts a pictorial representation of a network of data processing systems in which illustrative embodiments may be implemented;

FIG. 2 is a block diagram of a data processing system in which illustrative embodiments may be implemented;

FIG. 3 is a block diagram of high level components comprising a message re-synchronizer, in accordance with illustrative embodiments;

FIG. 4 is a block diagram of message flows in two scenarios, in accordance with illustrative embodiments; and

FIG. 5 is a flowchart of a process of synchronizing flows between transaction processing systems, in accordance with illustrative embodiments.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

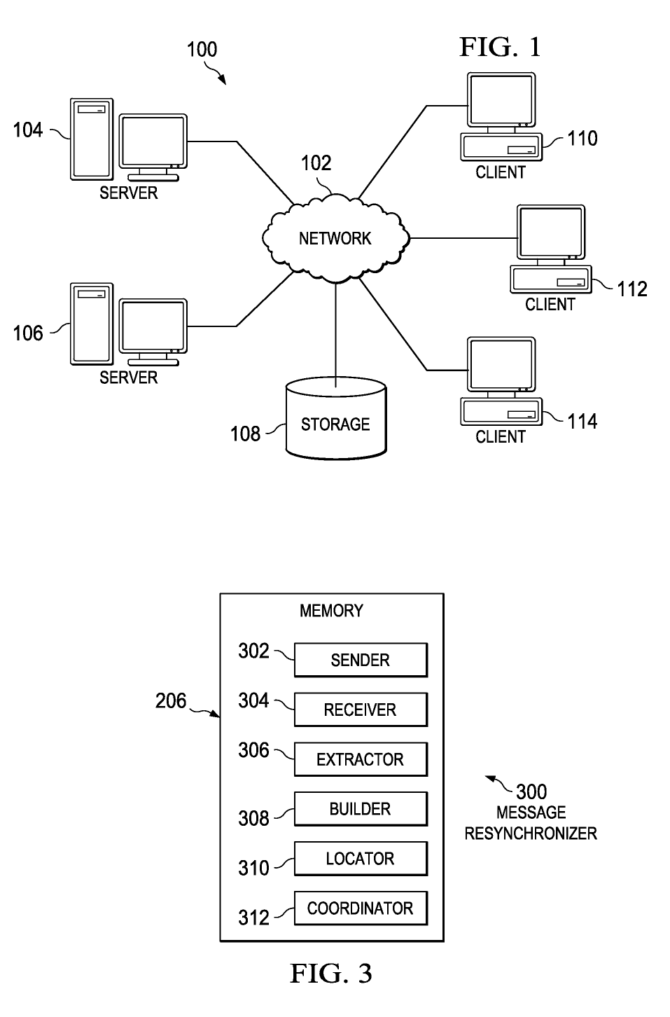

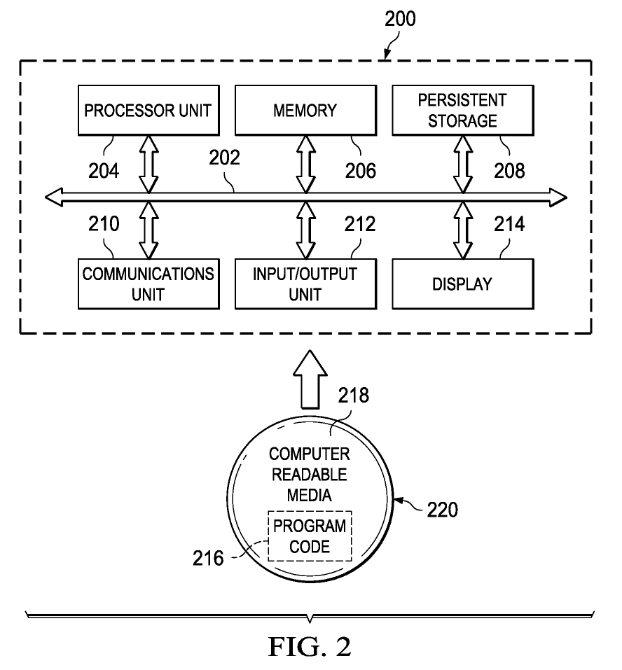

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

Implementations, in accordance with illustrative embodiments such as those of system 100 of FIG. 1, provide a transaction processing system, located on a server 106, with a capability to locate the information the system needs to for all outstanding transactions and to build the outstanding transactions into a single message. The single message may then be sent across the network, such as network 102 to a corresponding system that participates in the transaction processing. The recipient of such a single message, such as a transaction processing system on server 104, then extracts information relating to the individual transactions contained in the message data and proceeds to act upon the extracted information, processing each transaction in turn. The transaction processing system on server 104 then builds and sends back another single message containing the outcome for each transaction in the original message. A maximum of four such flows may therefore be needed between any pair of transaction processing regions of server 104 and server 106 to complete the resynchronization operation. The reduction in the number of message flows that are needed when there are large numbers of global transactions may then be reduced significantly compared with the current approach requires several flows for each of them.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, compute-usable program code, or compute-readable program code that may be read and executed by a processor in processor unit 204. The program code in the different embodiments may be embodied on different physical or tangible compute-readable media, such as memory 206 or persistent storage 208.

Program code 216 is located in a functional form on compute-readable media 218 that is selectively removable and may be loaded onto or transferred to data processing system 200 for execution by processor unit 204. Program code 216 and compute-readable media 218 form computer program product 220 in these examples. In one example, compute-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, compute-readable media 218 also may take the form of a persistent storage, such as a hard drive, a thumb drive, or a flash memory that is connected to data processing system 200. The tangible form of compute-readable media 218 is also referred to as compute-recordable storage media. In some instances, compute-recordable media 218 may not be removable.

Alternatively, program code 216 may be transferred to data processing system 200 from compute-readable media 218 through a communications link to communications unit 210 and/or through a connection to input/output unit 212. The communications link and/or the connection may be physical or wireless in the illustrative examples. The compute-readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and compute-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

With reference to FIG. 3, a block diagram of high level components comprising a message re-synchronizer in accordance with illustrative embodiments is shown. Message re-synchronizer 300 is an example of a synchronization mechanism that provides a capability to recover transactions after some form of processing or communication outage has occurred. Message re-synchronizer 300 is shown located within memory 206 of system 200 of FIG. 2, but may also be located in persistent storage 208 as is known in the art, until required for execution.

Message re-synchronizer 300 contains multiple components comprising sender 302, receiver 304, extractor 306, builder 308, locator 310 and coordinator 312. The components cooperate to deliver the services for message resynchronization. Sender 302 and receiver 304 provide corresponding message sending and receiving capability required during the synchronization process. Builder 308 and extractor 306 provide capability to construct a single message comprising multiple transactions on a sending system and to pick the transactions from the message on receipt at the receiving system. Locator 310 finds the outstanding transactions on a system that are in need of recovery. Coordinator 312 maintains a status of a transaction during its processing life. The transaction status includes an indication of the situation in which the decision state such as been voted “yes” but not yet received a decision and the situation in which a decision was sent but a confirmation has not yet been received.

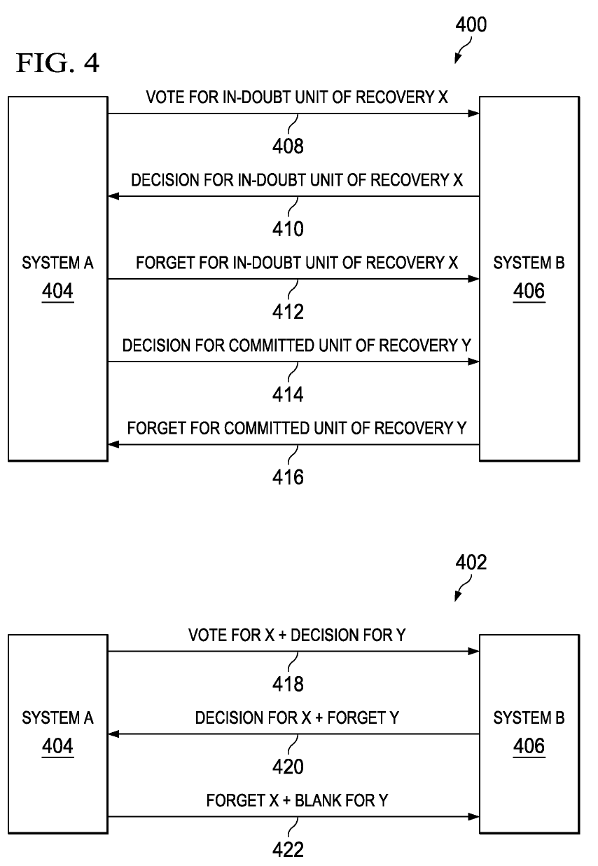

With reference to FIG. 4, a block diagram of message flows in two scenarios is shown. In the examples of FIG. 4, example 400 depicts a recovery process before application of enhancements in accordance with illustrative embodiments of the present invention. A global transaction consists of separate units of recovery on each of the transaction processing systems where it executes.

Following a systems failure or the loss of a connection between systems, some of these units of recovery can be in an in-doubt state, where they have voted ‘yes’ during the prepare phase of the synchronization point operation but have not received a decision from their coordinator. Others may have sent a decision but have not received confirmation of its delivery and as such, are in a committed state but waiting for a forget flow. When a transaction processing system is attempting to resynchronize a unit of recovery that is in-doubt, it sends a message to the coordinating system asking for the decision again. Upon receipt of such a message, the coordinator looks for the relevant unit of recovery on its system and sends back a message indicating what the decision is. An acknowledgment of the receipt of this decision can then be returned to the coordinator.

In a case when a transaction processing system is attempting to resynchronize a unit of recovery that is in a completed state but waiting for a forget flow, the decision for the global transaction is sent to the partner system. The partner then completes the appropriate unit of recovery, if found, and returns a forget message to the coordinating system. Example 400 shows the message exchange for a pair of systems, system A 404 and system B 406, that have two outstanding global transactions between them. The resynchronization operation is being driven from system A 404, where there are two units of recovery that require processing: one is in-doubt while the other is committed and waiting for a forget response. A message containing a vote for in-doubt unit of recovery X 408 is sent from system A 404 to system B 406. A corresponding message containing a decision for in-doubt unit of recovery X 410 is returned to system A 404. System A 404 then responds with a forget for in-doubt unit of recovery X 412 message, indicating system B 406 should not process X any further. A message containing a decision for committed unit of recovery Y 414 is sent from system A 404 to system B 406. System B 406 responds with a forget for committed unit of recovery Y 416 message to system A 404. The two units of recovery have been resolved.

In the next example 402, messages are exchanged for recovery of the same two units as in example 400, in accordance with illustrative embodiments. A message containing a vote for X+decision for Y 418 is sent from system A 404 to system B 406. A response message containing a decision for X+forget Y 420 is then built on system B 406 and sent to system A 404. System A 404 sends a response to system B 406 containing forget X+blank for Y 422 to complete the process of recovery. Fewer messages were used to accomplish the same task of example 400.

As seen in example 402, a transaction processing system undertaking a resynchronization operation first finds the information relating to all of the units of recovery for a particular connection that need re-synchronizing. The system, such as system A 404, then builds a single message containing this recovery information and sends the single message to the partner system, such as system B 406 in the example. The partner system then extracts the information relating to each unit of recovery and processes the transaction information. Having completed the work for all of the items in the message, the processing system then builds a single response message that is returned to the originating system. There, the information relating to each unit of recovery is received and acted upon before a final message is sent to the partner system. The partner system then completes any operations relating to any outstanding units of recovery that it has on the system.

On busy systems, there are likely to be many global transactions that need to be re-synchronized following a system or network failure. The number of messages that are exchanged may become significantly less when a recovery process in accordance with illustrative embodiments is used. Overhead of building and taking apart the large multiple transaction messages may be insignificant compared to the transport costs for many individual messages. As a consequence, the overall resynchronization operation may typically be shortened when there are large numbers of global transactions to process.

Additionally, in cases where there are units of recovery waiting for a forget flow from a participant in a global transaction, and the forget message is lost as the result of the system or connection failure, process time is reduced. The message overhead from this scenario for one of a pair of systems is reduced because during the resynchronization operation, one system sends a message containing information on all the units of recovery that the system is aware of and wishes to process. The transaction processing system that receives the message can infer from the message that any global transactions that the receiving system knows about and which are not found in the message must have been completed, and as a result, there is no need to send decisions relating to the transactions back to the partner system.

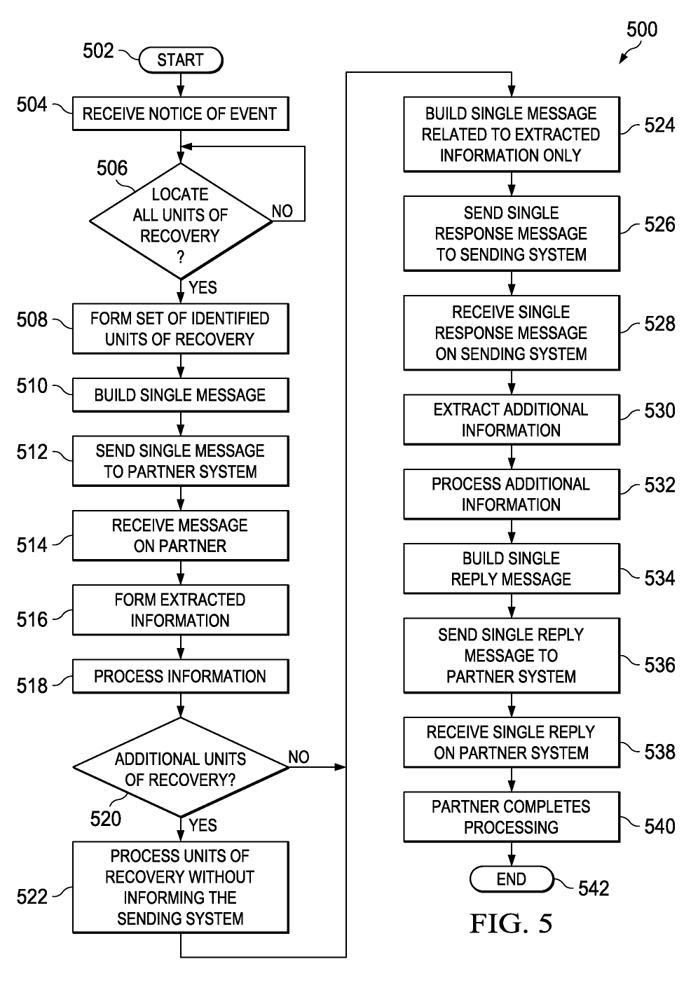

With reference to FIG. 5, a flowchart of a process of synchronizing flows between transaction processing systems in accordance with illustrative embodiments is shown. Process 500 is an example of the use of message re-synchronizer 300 of FIG. 3.

Process 500 starts (step 502) and receives notice of an event (step 504). The event is a processing or communication failure causing transaction processing to be suspended or stopped. A determination is made whether a locate of all units of recovery occurred (step 506). If all units of recovery were found a “yes” results. If a locate of all units of recovery could not be performed a “no” results. When a “no” is obtained in step 506, process 500 loops back to step 506 to locate more units of recovery. When a “yes” is obtained the located units form a set of identified units of recovery (step 508).

A single message containing the identified units of recovery is built (step 510). The single message is then sent to the partner or receiving system for processing (step 512). The partner system receives the single message from the sending system (step 514). On the receiving system, the units of recovery information is extracted from the single message to form extracted information (step 516). The extracted information is then processed as process information for a respective transaction (step 518).

A determination is made on the receiving partner system as to whether there are additional units of recovery (step 520). If there are additional units of recovery a “yes” results. If there are no additional units of recovery a “no” results. When a “no” results, process 500 skips ahead to step 524. When a “yes” results in step 520, processing of units of recovery without informing the sending system is performed (step 522). The additional units are located on the receiving partner system and processed by the receiving partner system.

The receiving partner system builds a single message related to extracted information only (step 524). Processing information related to the additional units of recovery is not included in the single message. The receiving partner system sends the single response message to the sending system (step 526). The single response message is then received on the originating sending system for processing (step 528).

Extract additional information from the response message occurs on the originating sending system (step 530). The additional information pertains to the information resulting from the receiving system processing. The additional information is processed on the originating sending system (step 532). As a result of processing the additional information, a further build of a single reply message is performed (step 534). The single reply message is then sent to the partner system (step 536).

The single reply message is received on the partner system (step 538) and the message content is processed as the partner system completes processing (step 540). Process 500 terminates thereafter (step 542).

In the examples provided, a transaction processing system, in accordance with illustrative embodiments, provides a capability to locate the information the system needs for all outstanding transactions and to build the outstanding transactions into a single message. The single message may then be sent across the network, to a corresponding partner system that participates in the transaction processing. The recipient of such a single message then extracts information relating to the individual transactions contained in the message data and proceeds to act upon the extracted information, processing each transaction in turn. The partner transaction processing system then builds and sends back another single message containing the outcome for each transaction in the original message. A maximum of four such flows may therefore be needed between any pair of transaction processing regions or systems to complete the resynchronization operation.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for synchronizing flows between transaction processing systems, the computer implemented method comprising:
locating all units of recovery for a particular connection to form a set of identified units of recovery;
building a single message containing the set of identified units of recovery; and
sending the single message from a sending system to a partner system for processing.

2. The computer implemented method for synchronizing flows between transaction processing systems of claim 1, wherein the step of sending the single message to the partner system for processing further comprises:
receiving the single message on the partner system;
extracting information related to each identified unit of recovery in the single message to form extracted information;
processing the extracted information for the each identified unit of recovery to create a processed identified unit of recovery to form processed information;
determine whether there are additional units of recovery, absent from the single message, related to the sending system;
responsive to a determination that there are additional units of recovery, absent from the single message, related to the sending system, processing the additional units of recovery without informing the sending system; and
building a single response message using the processed information, wherein the single response message includes information related to the extracted information only; and
sending the single response message to the sending system.

3. The computer implemented method for synchronizing flows between transaction processing systems of claim 2, wherein the sending the single response message to the sending system further comprises:
receiving the single response message on the sending system;
extracting further information related to each processed identified unit of recovery to form additional information;
processing the additional information for each processed identified unit of recovery to form processed additional information;
building a single reply message using the processed additional information; and
sending the single reply message to the partner system, wherein the partner completes processing of each processed identified unit of recovery.

4. A computer program product for synchronizing flows between transaction processing systems, the computer program product comprising:
a computer-readable recordable type medium embodying computer executable instructions, the computer executable instructions comprising:
computer executable instructions for locating all units of recovery for a particular connection to form a set of identified units of recovery;
computer executable instructions for building a single message containing the identified units of recovery; and
computer executable instructions for sending the single message from a sending system to a partner system for processing.

5. A data processing system for synchronizing flows between transaction processing systems, the data processing system comprising:
a bus;
a memory connected to the bus, the memory comprising computer executable instructions;
a processor unit connected to the bus, wherein the processor executes the computer executable instructions directing the data processing system to:
locate all units of recovery for a particular connection to form a set of identified units of recovery;
build a single message containing the set of identified units of recovery; and
send the single message from a sending system to a partner system for processing.
